(19) United States
(12) Patent Application Publication
(10) Pub. No.: US 2009/0049211 A1
(43) Pub. Date: Feb. 19, 2009

(54) ESTIMATING BACKEND PROCESSING TIME FOR RETRIEVING AND PROCESSING DATA AND DISPLAYING APPROPRIATE SUPPLEMENTAL CONTENT

(75) Inventors: Pasha SADRI, Menlo Park, CA (US); Daniel Joseph RAFFEL, San Francisco, CA (US); Jonathan James TREVOR, Santa Clara, CA (US); Edward HO, San Jose, CA (US); Kevin Cheng, San Francisco, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/838,807

(22) Filed: Aug. 14, 2007

(51) Int. Cl. G06F 3/00

(52) U.S. Cl. 710/61

(57) ABSTRACT

A method is complementary to processing a retrieve and process pipe specification. The pipe specification is characterized by at least one constituent pipe, each constituent pipe being characterized by at least one of a group consisting of an input node and an output node. The input node is configured to input data, such as a syndication data feed or other data accessible via a web service and the output node is configured to output data, such as a syndication data feed. At least one of the constituent pipes includes a module configured to retrieve data via a web service, such as a source syndication data feed. The wires are configured according to the retrieve and process pipe specification. An amount of time to process the pipe specification is estimated, including an amount of time to retrieve data via the web services as specified in the pipe specification. Based at least in part on the estimated amount of time, appropriate supplemental content is determined to present to a user while the pipe specification is being actually processed.

### BACKGROUND

It has been disclosed in U.S. patent Ser. No. 11/613,960 (YAH1P039/Y01804US01, “the '960 application”), filed Dec. 20, 2006, to configure a “pipe specification” to “wire together” component pipes to process syndication data feeds. More particularly, a process has been disclosed in the '960 application by which one may effect the remixing of syndication data feeds and, furthermore, to create syndication feed data “mashups” to combine content from more than one source, including at least one syndication data feed, into an integrated experience. As described in the '960 application, each module is characterized by at least one of a group consisting of an input node and an output node, wherein the input node, if present, is configured to input a syndication data feed and the output node, which is generally present, is configured to output a syndication data feed. At least one of the modules is a module configured to retrieve a source syndication data feed. The wires are configured to provide a syndication data feed provided from an output node of a module to an input node of another module.

FIG. 1 graphically illustrates an architecture in which pipe specifications may be executed. As shown in FIG. 1, a user 102 interoperates with a pipe specification service 104 via a network 106 (such as the internet) to cause the pipe specification service 104 to execute one or more pipe specifications 108. Generically, as disclosed in great detail in the '960 application, executing the one or more pipe specifications includes accessing a plurality of web services 108 (some examples of which are schematically illustrated as web services ws1 110(1), ws2 110(2), ws3 110(3), ws4 110(4), . . . , wsn 110(n)). The web services 110 collectively process syndication data feeds to accomplish execution of a pipe specification 108. A result of processing the pipe specification 108 is provided from the pipe specification service 104 to the user 102.

### SUMMARY

In accordance with an aspect, a method is complementary to processing a pipe specification. The pipe specification is characterized by at least one constituent pipe, each constituent pipe being characterized by at least one of a group consisting of an input node and an output node. The input node, if present, is configured to input a syndication data feed and the output node, if present, is configured to output a syndication data feed. At least one of the constituent pipes includes a module configured to retrieve a source syndication data feed. The wires are configured to connect each of at least some of the output nodes to at least one input node, including to provide a syndication data feed provided from an output node of a constituent pipe to an input node of another constituent pipe.

An amount of time to process the pipe specification is estimated, including an amount of time to retrieve syndication data feeds specified in the pipe specification. Based at least in part on the estimated amount of time, supplemental content is determined to present to a user while the pipe specification is being actually processed.

### BRIEF DESCRIPTION OF THE DRAWINGS

FIG. 1 graphically illustrates an architecture in which pipe specifications may be executed.

FIG. 2 illustrates a method in which a pipe specification is processed to present results and, furthermore, supplemental content is presented to the user while the pipe specification is being processed.

FIG. 3 illustrates an example architecture in which pipe specification metadata may be processed to estimate an amount of time to process the specified pipe and, based at least in part on the estimated amount of time, supplemental content is determined to present to the user while the pipe specification is being processed.

FIG. 4 illustrates a hierarchical organization of a pipe specification.

FIG. 5 is a simplified diagram of a network environment in which specific embodiments of the present invention may be implemented.

### DETAILED DESCRIPTION

The execution of a pipe may involve accessing many different web services, many, most or all of which are outside the control of the pipe provider. Thus, the execution of a pipe may take a relatively long time to return its results. Due in part to the abstract nature of a pipe specification, it typically would not be apparent from the pipe specification itself what will be the amount of time to return the results. In fact, the pipe specification itself may not even have enough information on its face to make a determination of what will be the amount of time.

The inventors have realized a desirability to present supplemental material to a user of a pipe specification, while the pipe specification is executing to retrieve and process various specified syndication data feeds and/or web services. The inventors have further realized a desirability to provide supplemental material that is appropriate to a nominal expected retrieval and processing time and/or is appropriate to a nominal expected content of the processed feeds.

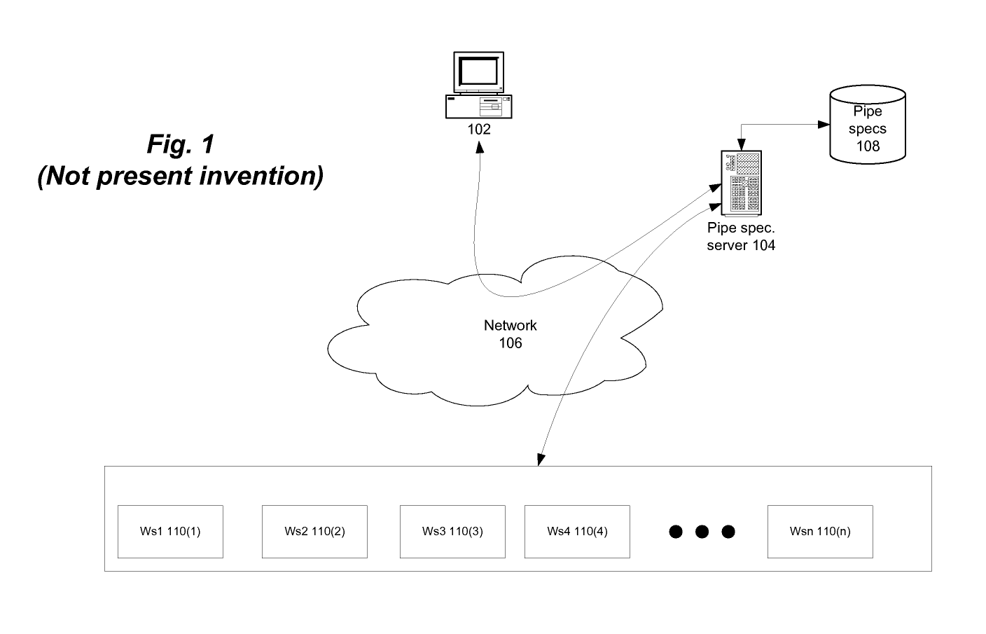

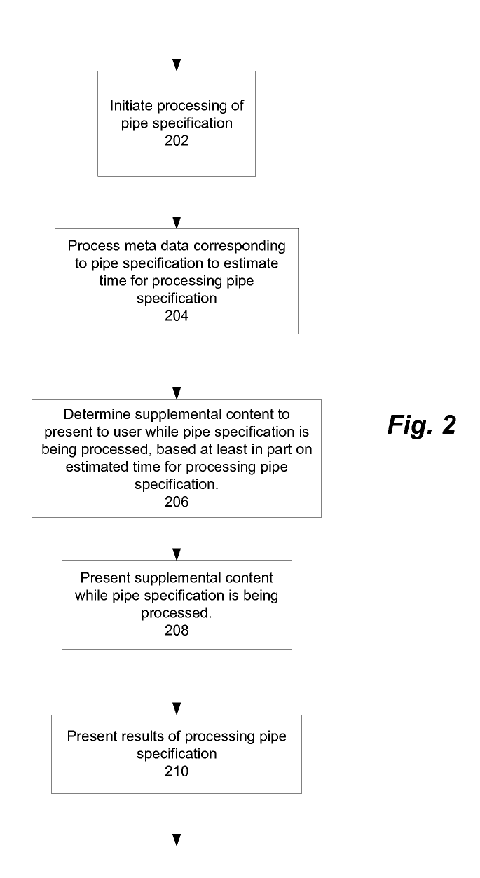

We now discuss, relative to FIG. 2, a method in which a pipe specification is processed to present results (such as to the user 102, of the FIG. 1 system) and, furthermore, supplemental content is presented to the user while the pipe specification is being processed. Turning now to FIG. 2, at 202, processing of a pipe specification is initiated. For example, as described in the '960 application, initiation of the pipe specification processing may be via a hosted service (e.g., operating on the pipe specification service 104 in FIG. 1) as a result of a user directly interacting with the hosted service or by interacting with another service that then interacts with the hosted service. The pipe specification processing includes causing access to one or more web services to retrieve and/or process various syndication data feeds. Again, examples of such processing are described in the '960 application.

At 204, metadata corresponding to the pipe specification is processed to estimate the time to process the pipe specification. For example, the metadata corresponding to the pipe specification may be stored in the pipe specification storage 108 in correspondence with the pipe specifications. Later, we describe several examples of processing the metadata corresponding to the pipe specification. At 206, based at least in part on the estimated amount of time, supplemental content is determined to present to the user while the pipe specification is being processed. We also later describe several examples of determining the supplemental content. At 208, the supplemental content is caused to be presented. At 210, the result of processing the pipe specification is caused to be presented.

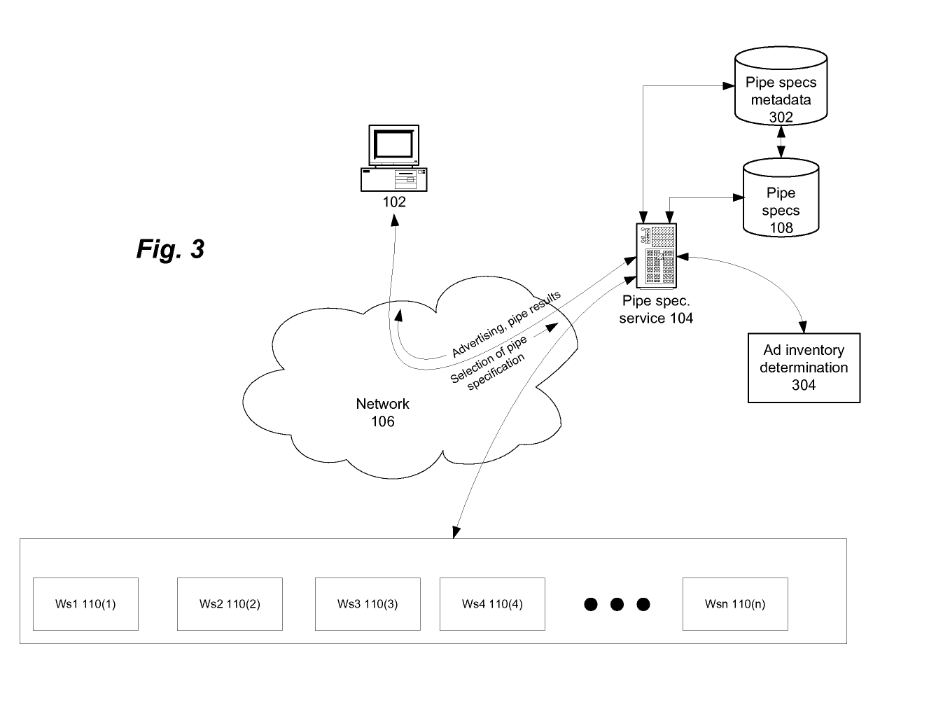

FIG. 3 illustrates an example architecture in which pipe specification metadata may be processed to estimate an amount of time to process the specified pipe and, based at least in part on the estimated amount of time, supplemental content is determined to present to the user while the pipe specification is being processed. Turning to FIG. 3, the architecture is similar to the FIG. 1 architecture. Pipe specifications metadata 302 is maintained in correspondence with the pipe specifications 108. The pipe specification service 104 is configured to receive a request from a user 102 to process a pipe specification request. The pipe specification service 104 is coupled to the pipe specification metadata 302 to, for example, access and process pipe specification metadata 302 to estimate an amount of time to process the pipe specified by the user 102.

In the FIG. 3 example architecture, the pipe specification service 104 is also coupled to an advertisement inventory 304, which is configured to interoperate with the pipe specification service 104 to cause advertisements as the supplemental content to be presented to the user 102 based at least in part on the estimated amount of time to process the pipe specified by the user.

We now describe some examples of processing metadata corresponding to the pipe specification. As we have discussed, a pipe specification may be comprised of a plurality of component pipe specifications, each of which may themselves be comprised of a plurality of component pipe specifications, and so on in a recursive manner. In accordance with a relatively simplistic example, the processed metadata may include simply the number of web service calls that result from processing the pipe specification, and the processing may be as simple as, for example, multiplying the number of web service calls by an estimated “average” amount of time per service call.

In accordance with other examples, the metadata to be processed and the processing itself may be informed by data representing actual processing times for previous executions of the pipe specification or, at least, in part by previous executions of component pipe specifications of the pipe specification. Thus, for example, where such metadata is available, processing time based on previous executions of component pipe specifications of the pipe specification may be used. The metadata may include information about the previous executions other than the processing time to more appropriately match the previous actual execution(s) with a current execution for which a processing time is to be estimated. For example, the additional information may include information about time of day of the previous execution or other information that may used to more closely match characteristics of the previous execution with the current execution that may affect the processing time.

On the other hand, for those component specifications for which such metadata is not available, the processing time for those component pipe specifications may be estimated in other ways, such as based on the number of web service calls. These estimations can be appropriately blended to determine an overall processing time estimate corresponding to the pipe specification.

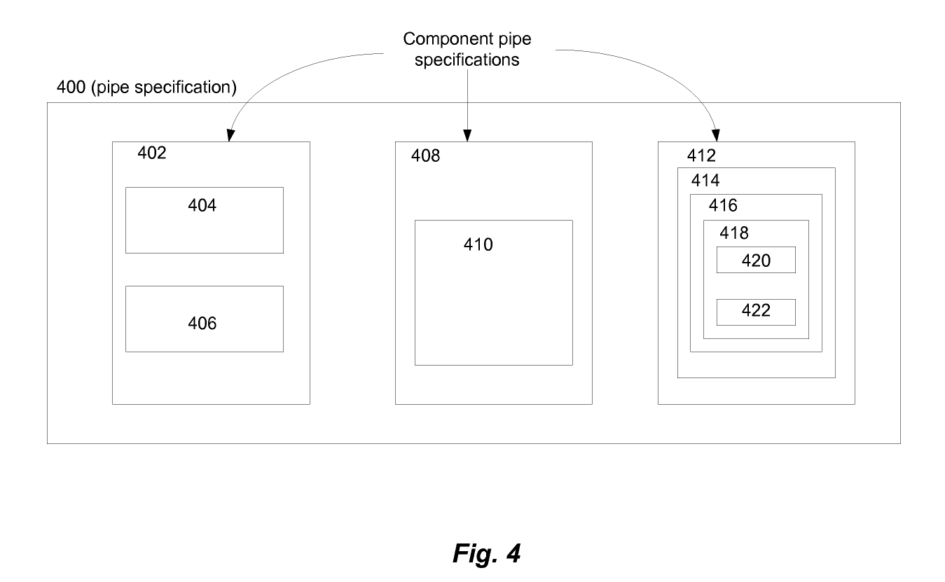

For example, FIG. 4 illustrates a hierarchical organization of a pipe specification 400. The pipe specification 400 includes component specifications 402, 408 and 412. Component specification 402 includes component specifications 404 and 406. Likewise, component specification 408 includes component specification 410. Component specification 412 has a slightly more complicated hierarchical organization.

Taking component specification 402 as an example, processing time metadata may be available for component specification 404 of component specification, but not for component specification 406 nor, for example, for the portions of component specification 402 not within component specification 404 and 406. Thus, for example, the processing time may be estimated using the processing time metadata for component specification 404, blended with an estimate for the other portions of component specification 402 determined using other methods.

We now discuss some examples of determining the supplemental content to be presented to the user while the selected pipe specification is being processed. In some examples, the supplemental content to be presented to the user may be determined by the pipes specification service or under the request or control of the pipe specification service. In other examples, such as some situations in which the pipe specification may be selected via an intermediate service such as a web page (e.g., via a badging station, as disclosed in the '960 application) or such as a feed reader (as also disclosed in the '960 application), the supplemental content to be presented to the user may be determined by the intermediate service or under the request or control of the intermediate service.

For example, the supplemental content may be determined at least in part by processing syndication data that has been returned as a result of previous executions of the pipe specification or by processing metadata that has been generated based on such previously-returned syndication data. For example, advertisement supplemental content determined in this manner may be likely related to the content of the current execution of the pipe specification. The supplemental content may be determined based on metadata associated with pipe specification, such as tags or categories that have been ascribed to the pipe specification (which may include, for example, tags or categories that have been ascribed to constituent pipes), such as manually by users or automatically. In other examples, the supplemental content may be determined to be, in general, not related to the pipe specification other than being appropriate to the estimated time to process the pipe specification (e.g., a video whose presentation time is appropriate to the estimated time to process the pipe specification).

Thus far, we have discussed presenting supplemental material that is appropriate to a nominal expected retrieval and processing time and/or is appropriate to a nominal expected content of the processed syndication data feeds. The execution of a pipe may be more generally characterized as a “retrieve and process” operation. That is, the pipe execution processing makes “calls” to other services (e.g., via available API's) to retrieve, mix and match from multiple data sources (which, in a specific example, are syndication data feeds). The nominal expected retrieval and processing time and/or nominal expected content may be estimated based on metadata corresponding to a “retrieve and process” specification.

We have thus described providing supplemental material that is appropriate to a nominal expected retrieval and processing time and/or is appropriate to a nominal expected content of the processed specifications for mixing and matching data resulting from various web service calls.

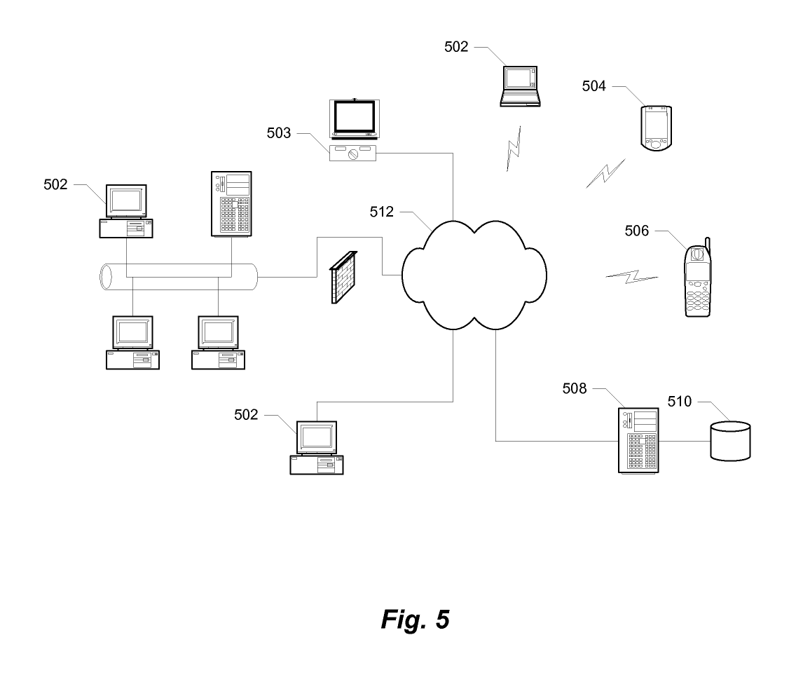

Embodiments of the present invention may be employed in any of a wide variety of computing contexts to provide supplemental material that is appropriate to a nominal expected retrieval and processing time and/or is appropriate to a nominal expected content of the processed specifications for mixing and matching data resulting from various web service calls s. For example, as illustrated in FIG. 5, implementations are contemplated in which users may interact with a diverse network environment via any type of computer (e.g., desktop, laptop, tablet, etc.) 502, media computing platforms 503 (e.g., cable and satellite set top boxes and digital video recorders), handheld computing devices (e.g., PDAs) 504, cell phones 506, or any other type of computing or communication platform.

According to various embodiments, applications may be executed locally, remotely or a combination of both. The remote aspect is illustrated in FIG. 5 by server 508 and data store 510 which, as will be understood, may correspond to multiple distributed devices and data stores.

The various aspects of the invention may also be practiced in a wide variety of network environments (represented by network 512) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

What is claimed is:

1. A method that is complementary to processing a pipe specification, the pipe specification being characterized by at least one constituent pipe, each constituent pipe being characterized by at least one of a group consisting of an input node and an output node, such that
the input node, if present, is configured to input a syndication data feed and the output node, if present, is configured to output a syndication data feed; and
at least one of the constituent pipes includes a module configured to retrieve a source syndication data feed;
the wires are configured to connect each of at least some of the output nodes to at least one input node, including to provide a syndication data feed provided from an output node of a constituent pipe to an input node of another constituent pipe;
the method comprising:
estimating an amount of time to process the pipe specification, including to retrieve syndication data feeds specified in the pipe specification; and
based at least in part on the estimated amount of time, determining supplemental content to present to a user while the pipe specification is being actually processed.

2. The method of claim 1, wherein:
determining the supplemental content includes processing a characterization of results of previous processing of that pipe specification.

3. The method of claim 1, wherein:
determining the supplemental content includes accessing advertisement inventory based at least in part on characterization of results of previous processing of that pipe specification and receiving the supplemental content from the advertisement inventory.

4. The method of claim 1, wherein:
estimating the amount of time to process the pipe specification is based at least in part on historical data regarding timing of processing the pipe specification.

5. The method of claim 4, wherein:
the historical data regarding processing the pipe specification includes historical data regarding timing of processing at least one constituent pipe of the pipe specification.

6. The method of claim 1, wherein:
determining the supplemental content is further based at least in part on metadata associated with the pipe specification.

7. The method of claim 6, wherein:
the metadata includes tags or categories associated with the pipe specification.

8. The method of claim 1, wherein:
estimating an amount of time to process the pipe specification is based at least in part on historical data regarding processing the pipe specification and is further based at least in part on characteristics associated with the pipe specification other than historical data regarding processing the pipe specification.

9. A system comprising at least one computing device configured to provide supplemental content to content resulting from processing a pipe specification, the pipe specification being characterized by at least one constituent pipe, each constituent pipe being characterized by at least one of a group consisting of an input node and an output node, such that
the input node, if present, is configured to input a syndication data feed and the output node, if present, is configured to output a syndication data feed; and
at least one of the constituent pipes includes a module configured to retrieve a source syndication data feed;
the wires are configured to connect each of at least some of the output nodes to at least one input node, including to provide a syndication data feed provided from an output node of a constituent pipe to an input node of another constituent pipe;
wherein the at least one computing device is configured to:
estimate an amount of time to process the pipe specification, including to retrieve syndication data feeds specified in the pipe specification; and
based at least in part on the estimated amount of time, determine supplemental content to present to a user while the pipe specification is being actually processed.

10. The system of claim 9, wherein:
being configured to determine the supplemental content includes being configured to process a characterization of results of previous processing of that pipe specification.

11. The system of claim 9, wherein:
being configured to determine the supplemental content includes being configured to access advertisement inventory based at least in part on characterization of results of previous processing of that pipe specification and to receive the supplemental content from the advertisement inventory.

12. The system of claim 9, wherein:
being configured to estimate the amount of time to process the pipe specification is based at least in part on historical data regarding timing of processing the pipe specification.

13. The system of claim 12, wherein:
the historical data regarding processing the pipe specification includes historical data regarding timing of processing at least one constituent pipe of the pipe specification.

14. The system of claim 9, wherein:
being configured to determine the supplemental content is further based at least in part on metadata associated with the pipe specification.

15. The system of claim 14, wherein:
the metadata includes tags or categories associated with the pipe specification.

16. The system of claim 9, wherein:
being configured to estimate an amount of time to process the pipe specification is based at least in part on historical data regarding processing the pipe specification and is further based at least in part on characteristics associated with the pipe specification other than historical data regarding processing the pipe specification.

17. A method that is complementary to processing a retrieve and process pipe specification of processing that includes making calls to web-based services to mix and match from multiple data sources, the retrieve and process pipe specification being characterized by at least one constituent retrieve and process constituent pipe, each constituent pipe being characterized by at least one of a group consisting of an input node and an output node, such that
the input node, if present, is configured to input data and the output node, if present, is configured to output data; and
at least one of the constituent pipes includes a module configured to retrieve data using a web service;
the wires are configured to connect each of at least some of the output nodes to at least one input node, including to provide output data provided from an output node of a constituent pipe to an input node of another constituent pipe the method comprising:
estimating an amount of time to process the retrieve and process pipe specification, including to retrieve data using web services as specified in the retrieve and process pipe specification; and
based at least in part on the estimated amount of time, determining supplemental content to present to a user while the pipe specification is being actually processed.
